(19) United States
(12) Patent Application Publication
(10) Pub. No.: US 2007/0122789 A1
(43) Pub. Date: May 31, 2007

(54) Context aware tutorial

(76) Inventor: Sung W. Yoo, Chula Vista, CA (US)

Correspondence Address: FOLEY & LARDNER LLP, 321 NORTH CLARK STREET, SUITE 2800, CHICAGO, IL, 60610-4764, US

(21) Appl. No.: 11/288,470

(22) Filed: Nov. 29, 2005

(51) Int. Cl. G09B 7/00

(52) U.S. Cl. 434/323

(57) ABSTRACT

A tutorial for teaching users how to use a computer program. The tutorial presents context-aware information and suggestions regarding use of the computer program in a manner integrated with the normal display of the computer program. The tutorial is accessible in a non-linear manner, allowing users to enter or exit the tutorial throughout the computer program.

### BACKGROUND OF THE INVENTION

The present invention relates generally to the field of educational devices. Specifically, the present invention relates to software having a context aware non-linear tutorial.

People are almost continuously exposed to new and complex software programs in nearly every aspect of their lives. Users of such software face the daunting task of learning to use the software both proficiently and efficiently. Thus, software users need to be trained to use the software. This is particularly true for software used in the workplace, which is often unique or something the user had not been previously exposed to, such as business management software. Currently, software users can try to learn on their own, rely on help systems contained in the software itself or rely on outside resources such as seminars or personal tutorials. For complex software such as business management software, often lengthy out-of-office coursework or studies are needed. While this may be viable for larger entities, for small to medium sized businesses, sending staff out of the office to be trained is a luxury that they can't afford. Workshops or formal training necessary for complex software usually takes more time than seminars or one-on-one training sessions, which may suffice for simpler software. Typically, staff sent to seminars will be out of the office for a full day or more, especially if they have to travel to a training center, which is often an impossibility for small or moderate-sized businesses.

Furthermore, when organizations use software that is highly customized, consultant created, or specialized client specific software, it is generally necessary for the software vendor to provide extensive and often costly training support. Formal training generally does not work well for more customized applications such as comprehensive business management software, in part because different occupations within a business will use the software in very different ways.

Current tutorials included with computer programs suffer from a series of at least four faults. First, the tutorials normally require a user to have a sufficient level of knowledge to locate the information they need to access by browsing a list of topics or using simple search technologies. Second, most tutorials operate as a separate program providing an example of functionality without allowing the user to actually proceed through the tutorial using the program with “real” information or interactions. For those tutorials that allow the user the access the actual program, the user often faces a modified user interface, such as an interface which contains help windows, splits the display, or otherwise reduces the size or visibility of the normal program interface. This makes both using the program more difficult and makes the tutorial experience differ from “real-world” use of the program. Third, current tutorials generally require the user to proceed from a fixed starting point to a fixed end point, and the user is not able to use the program and only access the tutorial for features or situations where the user is unsure. Finally, the fourth fault in current tutorials is that they are blind to the particular type of user using the tutorial. Often, different users will require tutoring on different aspects of a program, particularly with complex business programming, i.e. what is useful for one individual may be a waste of time to display to another individual. Therefore, there is a need for a tutorial for a computer program that is context aware and non-linear, allowing different users to experience a tutorial as they actually use the program in the normal course of their work.

### SUMMARY OF THE INVENTION

One embodiment of the present invention relates to systems and methods for providing a tutorial teaching how to use a computer program. The tutorial provides a non-linear opportunity for users to interact with the program in a tutorial mode. The tutorial presents a context aware set of tutorial cues, providing instructions and directions regarding use of the software as appropriate for the specific context. The tutorial is integrated with the software program display so as to allow a user to experience the “normal” operation of the software program, with the tutorial cues superimposed over the normal display. Thus, the tutorial allows a user to actually use the software program as they would normally use it, even when in the tutorial mode.

These and other objects, advantages, and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a screen shot illustrating one embodiment of the present invention, wherein a user can enter or exit the tutorial via a pull-down menu or keystroke shortcut;

FIG. 2 is a partial screen shot illustrating one embodiment of the present invention using bubble text to indicate how a user should proceed to interact with the user interface;

FIG. 3 is a screen shot illustrating an embodiment of the present invention where there is more than one activity for the user to perform on the displayed content;

FIG. 4 is a screen shot of a business software interface having a button to activate the tutorial;

FIG. 5 is a screen shot of an exemplary tutorial training menu;

FIG. 6 is a screen shot of an exemplary tutorial for creating a shopping list for a purchase order;

FIG. 7 is a screen shot of an exemplary tutorial for finalizing a draft purchase order from the shopping list of FIG. 6; and

FIG. 8 is a screen shot of an exemplary purchase order generated from the draft purchase order of FIG. 7.

### DETAILED DESCRIPTION OF THE INVENTION

The present application relates to systems and methods for providing a nonlinear, context-specific tutorial. In one embodiment, the tutorial of the present invention is provided with respect to a computer program or other software, such as complex business management software, accounting software, spreadsheet or other productivity software. The tutorial provides a user with a learning experience in relation to the functionality of the underlying program for which the tutorial is used.

Current systems do not provide a user with a realistic experience often due to the use of separate display windows or areas that reduce the overall amount of space allotted to the program on a graphical user interface or display. For example, some current systems utilize a help function that, when in use, resides as a separate window to the side of the program, with the program being reduced so that both windows can fit on the display.

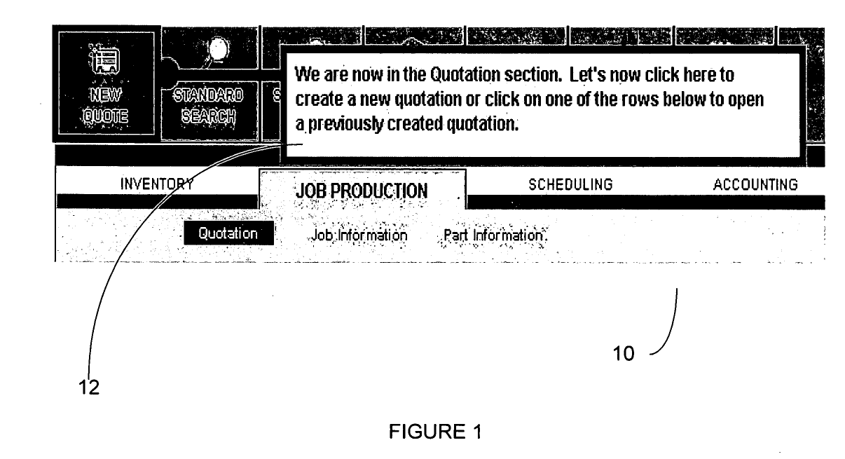

In one embodiment of the invention, the tutorial provides cues regarding the use of an associated program. The present invention relates to a tutorial which allows the associated program to be displayed as it normally appears, with the tutorial cues integrated in the display. In an exemplary embodiment, the tutorial cues comprise text boxes containing instructions regarding use of the program. As shown in FIG. 1, a tutorial cue text box 12 shown in a display or screen interface 10 (FIG. 1 is a partial view of the whole display) indicates instructions for the user and indicates what functions as displayed on the screen the user should interact with. In this example, the “new quote” button is discussed.

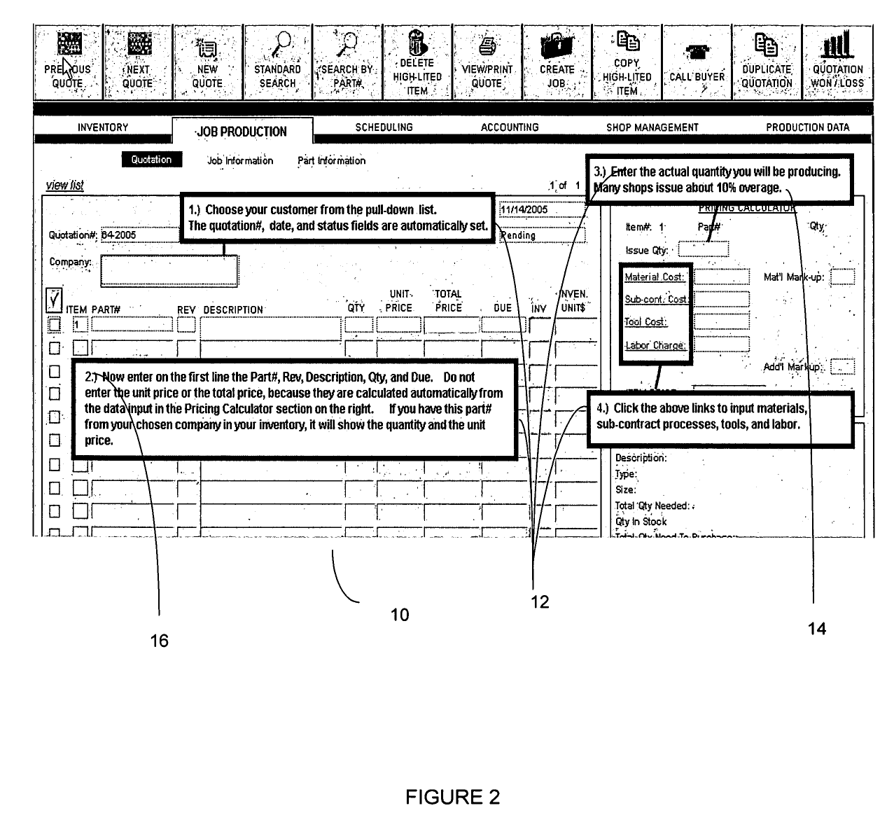

In one embodiment, illustrated in FIG. 2, a plurality of tutorial cues 12 are displayed on a screen interface 10 of the program. In an exemplary embodiment, where a user needs to perform more than one action or interact with more than one portion of a displayed screen 10, ordered tutorial cues are provided. The tutorial cues may be ordered in any number of ways to convey the appropriate order of action to a user, for example by numeric or alphabetic indication. FIG. 2 illustrates the use of a numeric indicator 16.

In one embodiment, additional information or suggestions may be provided to a user. For example, as shown in FIG. 2, a user may be provided with information regarding standard industry best practices. In an exemplary embodiment, the tutorial includes suggestion cues 14 for provide additional information that is not vital to the operation of the program. In one embodiment, such cues are textual boxes. In another embodiment, the suggestion cues are with the tutorial cues as shown in FIG. 2.

Presentation of the program during the tutorial as it would normally be displayed, provides several advantages over conventional systems. First, a user is presented with the same display and interface that they will experience when not using the tutorial. Second, the tutorial cues are integrated onto the display so as to allow the user to focus only on the program without having to refer to a separate window or printed document.

Conventional systems require a user to use data which is provided or do not allow the tutorial work to be integrated back into a master database or file. For example, some current systems provide a user no opportunity to input information. Instead, most or all of the information or choices that would normally be made by the user are pre-decided by the tutorial. Other current systems allow a user to enter actual information or to realistically interact with the program during the tutorial, such as by entering purchase order information in a business management program, but the activities performed during the tutorial are not transferable to the normal operation of the program, i.e. the purchase order is not actually created.

In one embodiment, the present invention allows a user to use actual data and perform their normal work functions while in the tutorial. For example, business management software having a tutorial in accordance with the principles of the present invention allows a user to enter purchase order information during a tutorial which would result in an actual purchase order being generated. In the present invention, the tutorial provides a user with the ability to perform real work while learning via the tutorial.

Allowing a user to experience the tutorial while still being able to normally interact with the program provides at least three advantages over current tutorials. First, the tutorial provides a more realistic, and therefore meaningful, experience to a user when the user is able to interact with the program as she would in the normal course of using the program outside of the tutorial. Second, the use of actual data allows for increased productivity and increased likelihood that the tutorial is used, as a user does not experience “down time” while using the tutorial, but rather continues to be able to perform their work. Finally, the use of actual data facilitates the use of a non-linear tutorial as further described below, allowing for greater flexibility and ease of use.

Conventional systems also utilize tutorials that are unable to adapt to a wide range of users, a particular problem for management software which often requires employees having dissimilar positions to utilize the same program. For example, a business management program may manage the workload for machines on the shop floor requiring use by a laborer. The program may also manage the inventory of the business requiring, the use by a planner, and accounting information may also be integrated into the program, requiring use by accountants. Conventional systems fail to recognize that complex programs having a plethora of functions will be used differently by different individuals depending on their experience, education, and job classification.

In one embodiment, the present invention is context sensitive, i.e. the tutorial is aware of variables such as user experience, user job classification, and user security level. In an exemplary embodiment, an employee may only access the tutorial for the functions of the program that relate to or are necessary for the employee to perform his or her job. A user would be able to enter and exit the tutorial, but would only receive tutorial cues providing instructions for those functions of the software relevant to the employee's job.

The ability of the present invention to operate in a context-aware manner has at least three advantages over current systems. First, an employer is able to prevent employees from learning how to use areas of the program outside of the scope of their job needs. Second, users are only presented with information (in the form of tutorial cues) that is necessary for their job function. This is particularly useful where the program is complex and includes a wide array of functions. Finally, the presentation of information regarding only certain functions or aspects of the program allows for a richer and detailed presentation of the functions and aspects that are presented by the tutorial. This includes the ability to tailor suggestions and best practices information based upon the context in which the tutorial is used.

Conventional systems provide the user with a linear tutorial, i.e. users must start from a predetermined point and end at a predetermined point, most often using sample data as previously discussed. Thus, current systems do not allow a user to selectively enter and exit the tutorial as needed as the user proceeds through the various aspects of the program in the normal course of their usage. In one embodiment, the present invention is non-linear. The tutorial allows a user to selectively enter or exit the tutorial mode at any point in the use of the program.

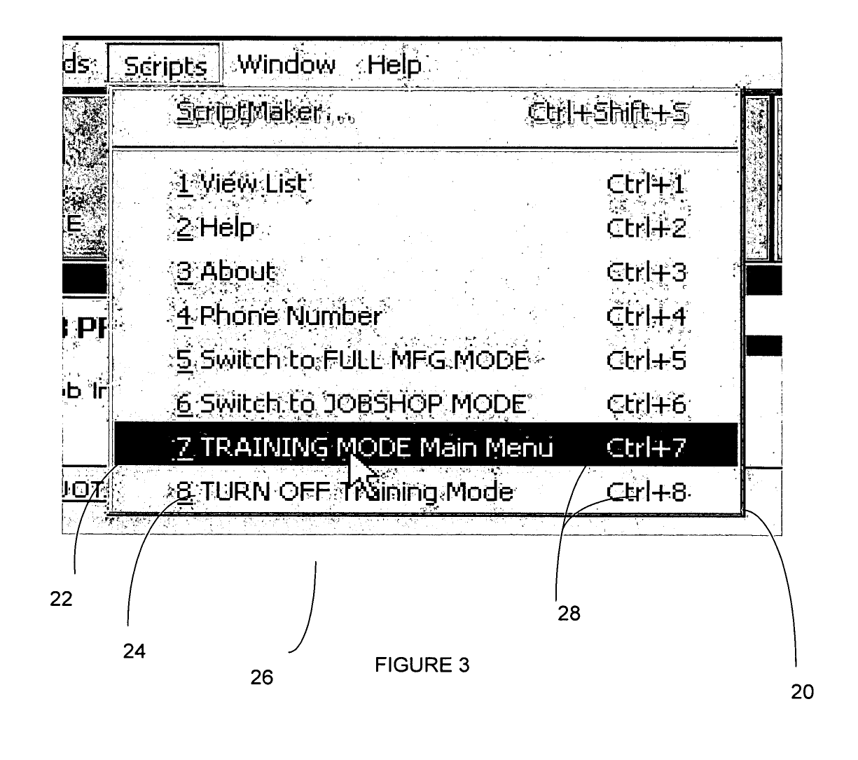

In one exemplary embodiment, the interface of the program for which the tutorial is provided includes a menu option for entering and for exiting the tutorial. For example, in one embodiment illustrated in FIG. 3, a drop down menu 20 is provided with an option for entering the training mode main menu 22 and an option for turning off the training mode 24. As illustrated in FIG. 3, the program interface 26 may also include shortcut functionality 28 allowing a user to enter and exit the training mode via a specific keystroke or series of keystrokes.

The use of a non-linear tutorial presents several advantages over current systems. First, the use of a non-linear tutorial allows for greater ease of use for providing a “refresher” for users who have a basic understanding of the program. Second, the non-linear systems provide for more flexible use. Users are free to access the tutorial as they work, thus learning about the program as they have a need to use those features rather than being forced to learn the entire program at once. Finally, since users are free to turn the tutorial on and off with no impact on their productivity, users are more likely to take advantage of the tutorial to learn about more advanced features of the program with which they might not be familiar. This can result in increased efficiency and/or productivity.

In one embodiment, the tutorial cues or suggestion cues comprise textual information as illustrated in FIGS. 1 and 2. In an alternative embodiment, tutorial cues and suggestion cues are provided as audio and/or video content instead of or in addition to textual content.

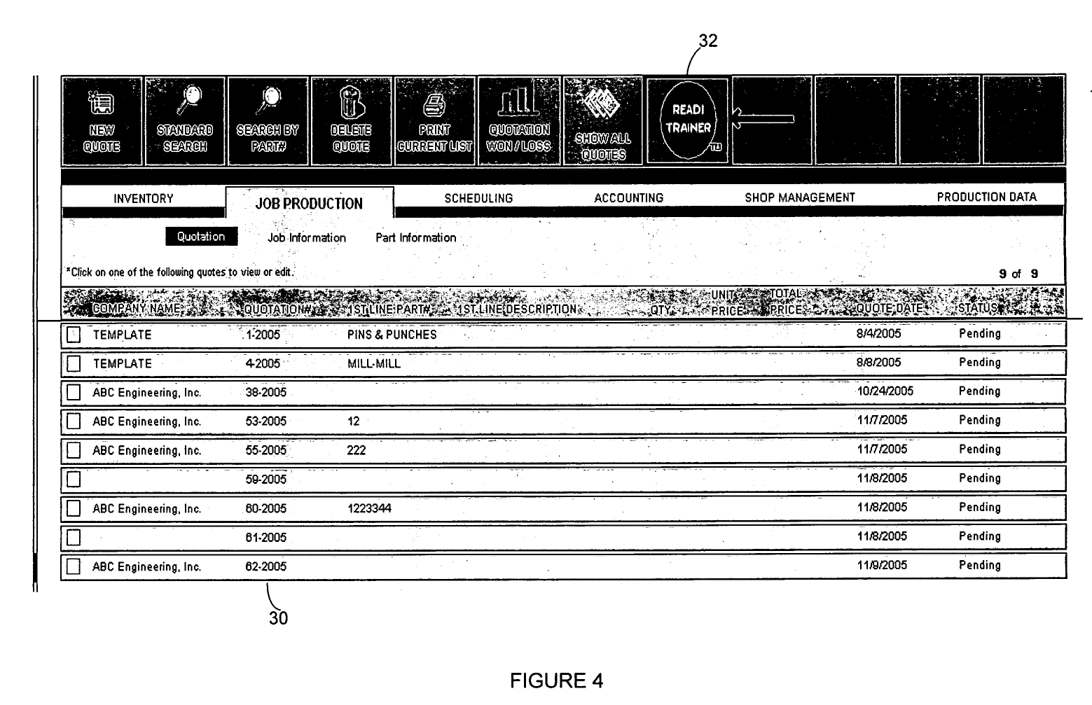

FIGS. 4-8 illustrate one exemplary embodiment of the present invention wherein a tutorial is used with business management software to teach a user how to generate a purchase order.

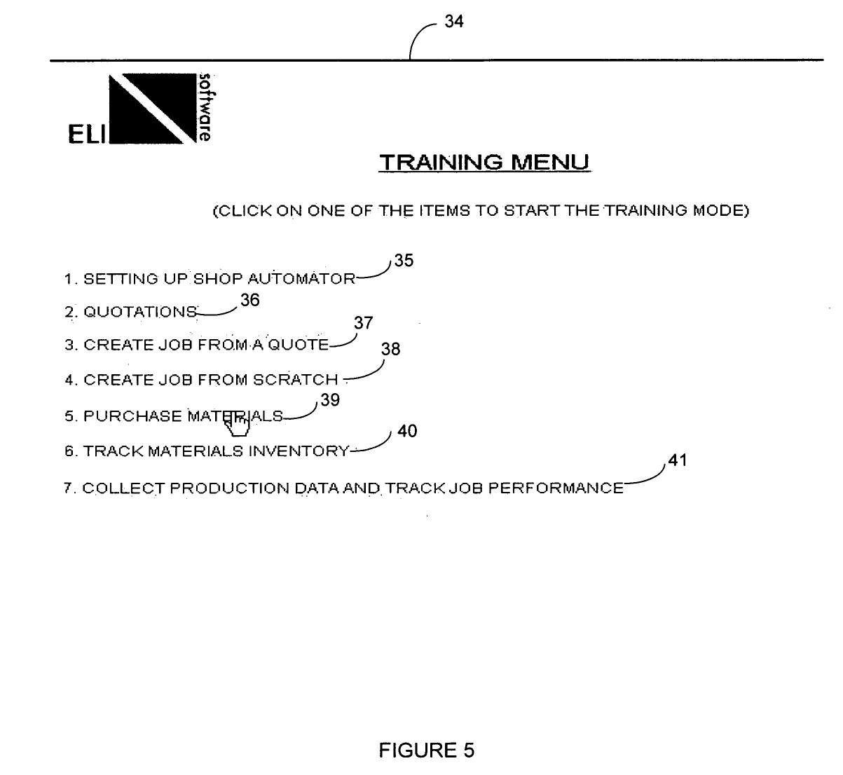

FIG. 4 illustrates a screen shot of the business management software interface 30 with a button 32 for the user to click to enter the tutorial. FIG. 5 illustrates a screen shot of a training menu 34 which is called up when the tutorial button 32 is activated. The training menu 34 includes options 35 for allowing a user to experience a tutorial on a discreet topic such as “setting up shop automator” 35, “quotations” 36, “create job from a quote” 37, “create job from scratch” 38, “purchase materials” 39, “track materials inventory” 40, and “collect production data and track job performance” 41. A user selects one of the options 35, such as “purchase materials” 39, which returns the user to the business software interface 30, but with the tutorial active as seen by the tutorial cues 12.

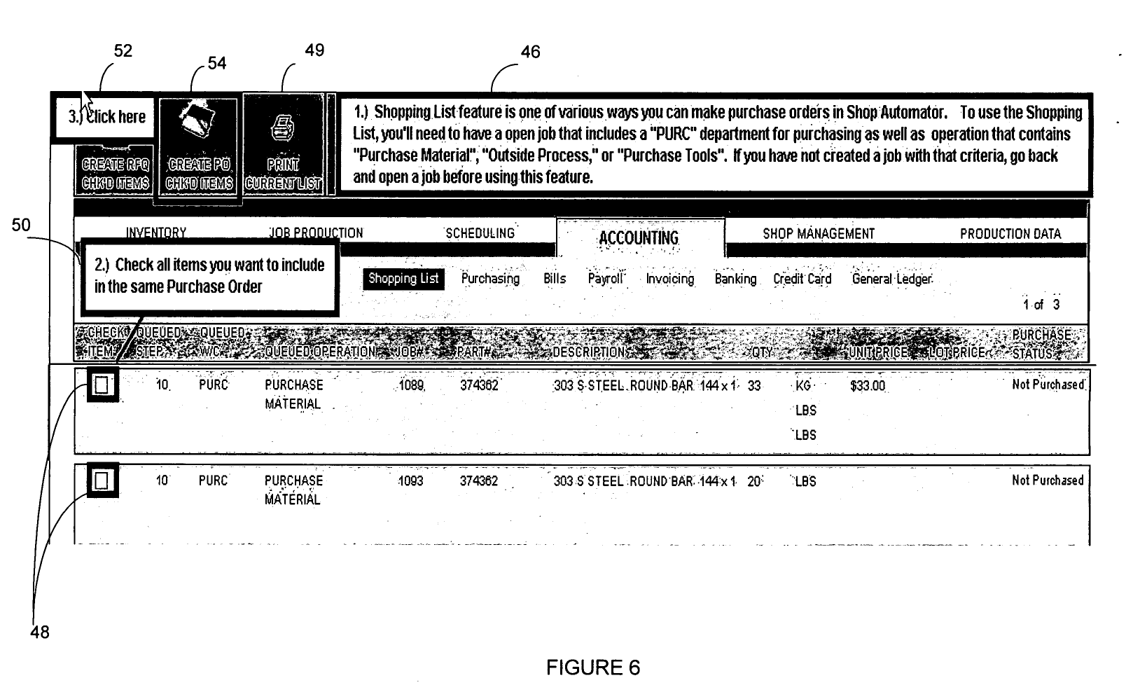

As seen in FIG. 6, the user is provided with tutorial cues 12 having numeric references indicating 16 the order in which the instructions should be performed. The screen shot of FIG. 6 illustrates how a user would generate a purchase order 44, such as by generating a shopping list 46 using actual materials to be purchased 48. The first tutorial cue 49 of FIG. 6 indicates to the user the use of the shopping list 46. The second tutorial cue 50 instructs the user to check the materials to be purchased 48. The third tutorial cue 52 indicates the user should click a “create purchase order” icon 54 to generate a draft purchase order 56 with the data just entered.

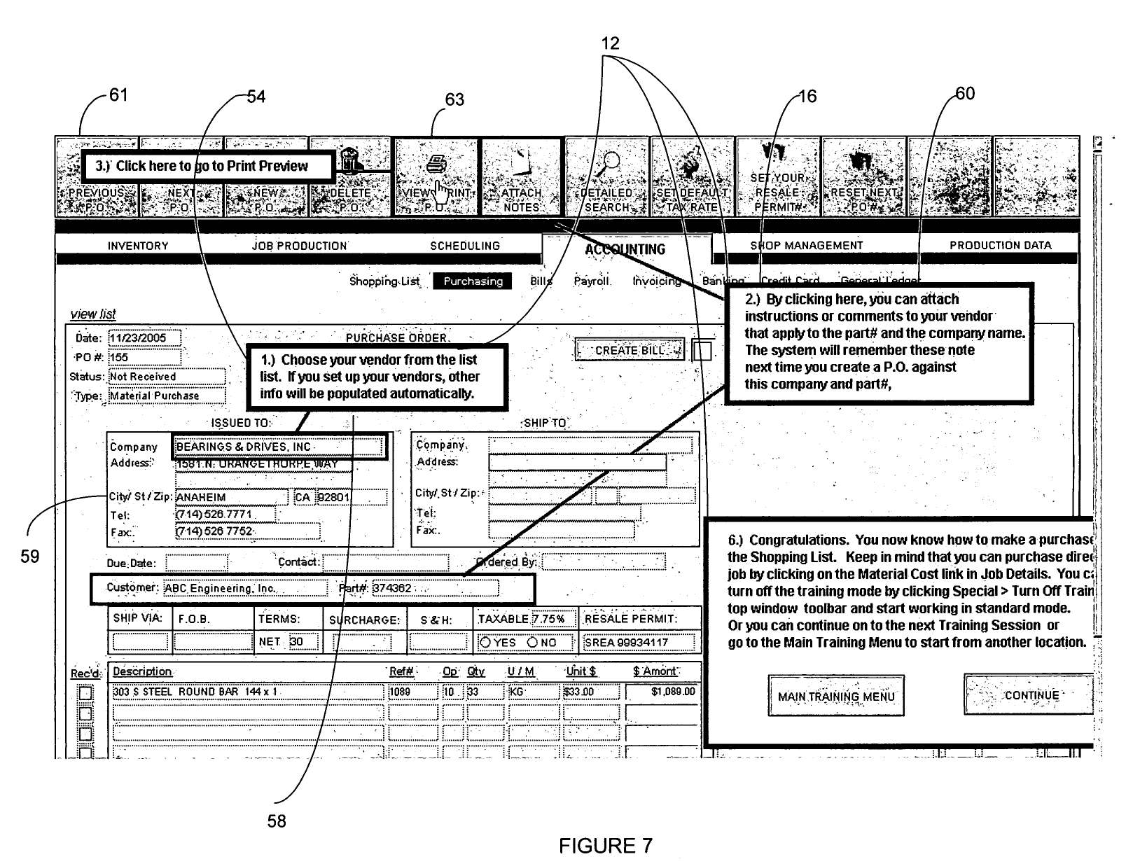

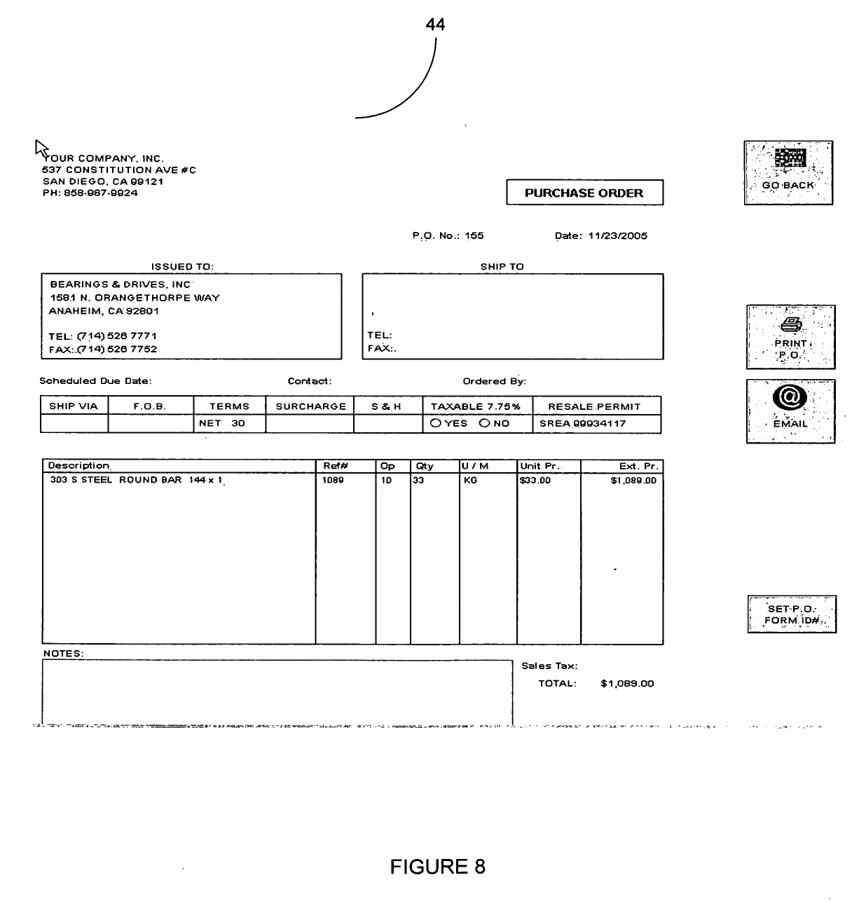

FIG. 7 is a screen shot of the draft purchase order called up when the user activates the “create purchase order” icon 54. As seen in FIG. 7, additional tutorial cues 12 are provided again indicating their order of performance with numeric indicators 16. The first tutorial cue 58 indicates the user may choose the vendor 59 for the purchase order. The second tutorial cue 60 indicates where that the user may attach a note to the purchaser order. A third tutorial cue 61 indicates the print preview button 63 where the user should click to produce a print of the purchase order 44. The user is then notified in a final tutorial cue 62 of FIG. 7 that the purchase order will be generated and the user is give the option to continue to the next step in tutorial mode or to return to the main training menu 34. FIG. 8 illustrates a print-preview of the purchaser order 44 generated through the tutorial mode which is identical to what would have been generated with the same data outside of the tutorial program.

In one embodiment, the tutorial of the present invention is integrated with a computer program or software. In another embodiment, the tutorial is a separate computer program that interacts with other computer programs to provide a learning experience for a user.

The present invention is described in the general context of method steps, which may be implemented in one embodiment by a program product including computer-executable instructions, such as program code, executed by computers in networked environments. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques, with rule based logic, and other logic to accomplish the various database searching steps, correlation steps, comparison steps and decision steps. It should also be noted that the words “software” and “computer program” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. While the present invention has generally been described in terms of a computer program, one skilled in the art will appreciate the applicability of the principles of the present invention across numerous platforms and hardware such as personal digital assistances, network or Internet applications, mobile telephones, or electronic entertainment devices. The embodiments were chosen and described in order to explain the principles of the present invention and its practical application to enable one skilled in the art to utilize the present invention in various embodiments, and with various modifications, as are suited to the particular use contemplated.

What is claimed is:

1. A method for providing a non-linear, context specific tutorial for a computer program, comprising:
selecting a tutorial mode, the tutorial mode presenting a tutorial for the computer program;
determining a context in which the tutorial will be presented;
presenting tutorial cues; and
displaying tutorial cues providing information regarding use of the computer program, the tutorial cues integrated with a standard display of the computer program;
wherein the selection of the tutorial mode may occur at a plurality of points in operation of the computer program.

2. The method of claim 1 wherein the tutorial cues include a reference indicating a preferred order of performance.

3. The method of claim 1, further comprising displaying integrated suggestion cues.

4. The method of claim 1, wherein the tutorial cues comprise content selected from a group consisting of textual content, audio content, video content, and combinations thereof.

5. The method of claim 4, wherein the tutorial cues are displayed as text boxes superimposed over the standard display of the computer program.

6. The method of claim 1, wherein determining the context comprises determining a user's employment classification.

7. A computer program product comprising,
computer code for selecting a tutorial mode, the tutorial mode presenting a tutorial for the computer program;
computer code for selecting determining a context in which the tutorial will be presented;
computer code for selecting presenting tutorial cues; and
computer code for selecting displaying tutorial cues providing information regarding use of the computer program, the tutorial cues integrated with a standard display of the computer program;
wherein the selection of the tutorial mode may occur at a plurality of points in operation of the computer program.

8. The computer program product of claim 8, wherein the tutorial cues include a reference indicating a preferred order of performance.

9. The computer program product of claim 8, further comprising computer code for displaying integrated suggestion cues.

10. The computer program product of claim 8, wherein the tutorial cues comprise content selected from the group consisting of textual content, audio content, video content, and combinations thereof.

11. The computer program product of claim 10, wherein the tutorial cues are displayed as text boxes superimposed over the standard display of the computer program.

12. The computer program product of claim 8, wherein determining the context comprises determining a user's employment classification.

13. A system for teaching the use of a computer program, the system comprising:
a computer network comprising at least one a computer program having a tutorial, the tutorial being selectively activateable at a plurality of operation points of the computer program; and
an identification key for accessing the computer network, the identification key providing a context for operation of the tutorial,
wherein the computer program tutorial includes at least one tutorial cue for integrated display with the computer program, the at least one tutorial cue providing information regarding operation of the computer program.

14. The system of claim 13, wherein the identification key comprises a user login.

15. The system of claim 13, wherein the at least one tutorial cue includes a reference indicating a preferred order of performance.

16. The system of claim 13, wherein the computer program tutorial includes at least one suggestion cue for integrated display with the computer program.

17. The system of claim 16, wherein the at least one tutorial cue comprises content selected from the group consisting of textual content, audio content, video content, and combinations thereof.

18. The system of claim 17, wherein the at least one tutorial cue is displayed as at least one text box superimposed over the computer program's normal display.

19. The system of claim 18, wherein the at least one suggestion cue is displayed in the at least one text box.
